(19) United States
(12) Patent Application Publication
(10) Pub. No.: US 2019/0287165 A1
(43) Pub. Date: Sep. 19, 2019

(54) RENTAL SYSTEM

(71) Applicant: HONDA MOTOR CO., LTD., Tokyo (JP)

(72) Inventors: Atsuyuki Suzuki, Wako-shi (JP); Naoko Imai, Wako-shi (JP); Tomoko Shintani, Wako-shi (JP)

(21) Appl. No.: 16/282,515

(22) Filed: Feb. 22, 2019

(30) Foreign Application Priority Data
Mar. 16, 2018 (JP) 2018-049836

(51) Int. Cl. G06Q 30/06; G06Q 10/02; G06Q 50/30

(52) U.S. Cl. CPC G06Q 30/0645; G06Q 50/30; G06Q 10/02

(57) ABSTRACT

An unavailability determination portion determines whether an unavailability condition indicating inability of use of a first storage space is met. When it is determined by the unavailability determination portion that the unavailability condition is met, a destination extraction portion extracts a second storage space that is at or within a predetermined distance from the first storage space and whose remaining time of a rentable period is not shorter than a second predetermined time. A destination information transmission portion transmits information on the second storage space to a provider terminal of a provider of the first storage space.

### INCORPORATION BY REFERENCE

The present application claims priority under 35 U.S.C. § 119 to Japanese Patent Application No. 2018-049836 filed on Mar. 16, 2018. The content of the application is incorporated herein by reference in its entirety.

### BACKGROUND OF THE INVENTION

### Field of the Invention

The present invention relates to a rental system that supports rental of a luggage storage space.

### Description of the Related Art

Conventionally, a matching support system has been proposed (for example, see International Publication No. WO2013/099964) in which mutual communication is performed between a supplier terminal used by a supplier supplying services and articles and a consumer terminal used by a consumer demanding provision of the services and articles, to match supply information transmitted from the supplier terminal and consumer information transmitted from the consumer terminal. The result of matching is transmitted to the supplier terminal and the consumer terminal.

As described in the above International Publication No. WO2013/099964, as a form of effectively utilizing resources owned by the supplier, spare space in a store such as a restaurant may be rented out to a traveler or the like as a temporary luggage storage space.

However, when a storage space is rented out in such a form, the following inconveniences arise. That is, if a schedule of the traveler who is the user of the storage space changes and the user cannot go to the store to collect luggage within the scheduled storage space use period he/she initially requested at the time of storage and the store closes, the user cannot collect the luggage. Additionally, in a case where store hours is reduced and the store closes within the scheduled use period the user initially requested at the time of storage, too, the user cannot collect his/her luggage.

The present invention has been made in view of the foregoing, and aims to provide a rental system that can prevent a situation where a user of a storage space cannot collect stored luggage.

### SUMMARY OF THE INVENTION

A rental system of an aspect of the present invention includes: a rental registration information acquisition portion that acquires, from a rental registration information storage portion that stores therein rental registration information containing a location of a luggage storage space, a rentable period of the storage space, and information on a terminal device used by a provider of the storage space, for each of a plurality of storage spaces, the rental registration information of each storage space; a usage state detection portion that detects a usage state of a storage space having the rental registration information stored in the rental registration information storage portion; an unavailability determination portion that determines, when it is detected by the usage state detection portion that a first storage space having the rental registration information stored in the rental registration information storage portion is in use or is scheduled to be used, whether an unavailability condition indicating inability of use of the first storage space is met; a destination extraction portion that, when it is determined by the unavailability determination portion that the unavailability condition is met, extracts a second storage space that is at or within a predetermined distance from the first storage space and whose remaining time of the rentable period is not shorter than a first predetermined time, from among other storage spaces having the rental registration information stored in the rental registration information storage portion; and a destination information transmission portion that transmits information on the second storage space extracted by the destination extraction portion to a terminal device of a provider of the first storage space or a terminal device of a user of the first storage space.

According to the aspect of the present invention, the rental registration information acquisition portion acquires the rental registration information of each storage space from the rental registration information storage portion. The usage state detection portion monitors the usage state of each storage space. When it is determined by the unavailability determination portion that an unavailability condition indicating inability of use of the first storage space is met, a second storage space that is at or within a predetermined distance from the first storage space and whose remaining time of the rentable period is not shorter than a first predetermined time is extracted by the destination extraction portion. Then, the destination information transmission portion transmits information on the second storage space to a terminal device of a provider of the first storage space or a terminal device of a user of the first storage space. Accordingly, the provider of the first storage space can transfer luggage stored in the first storage space to the second storage space, or the user of the first storage space can request transfer of the luggage stored in the first storage space to the second storage space to the provider of the first storage space, for example. The user storing the luggage in the first storage space can collect the luggage at the second storage space. Hence, a situation where the user storing the luggage in the first storage space cannot collect the luggage can be prevented.

In another configuration, detection by the usage state detection portion that the first storage space is continuously used when the remaining time of the rentable period indicated by the rental registration information is no longer than a second predetermined time, may be set as the unavailability condition.

According to this configuration, a continuously usable second storage space near the first storage space is extracted by the destination extraction portion when a user of the first storage space does not come to collect luggage even when the remaining rentable period of the first storage space is no longer than the second predetermined time. Then, the destination information transmission portion transmits information on the second storage space to the terminal device of the provider of the first storage space or the terminal device of the user. Hence, the provider of the first storage space or the user can transfer the luggage stored in the first storage space to the second storage space.

In another configuration, when use extension request information requesting extension of a scheduled use period of the first storage space initially set at the time of requesting usage is received from the terminal device of the user of the first storage space while it is detected by the usage state detection portion that the first storage space is in use or is scheduled to be used, an ending time point of the scheduled use period extended according to the use extension request information exceeding a limit of the rentable period of the first storage space, or the remaining time from the ending time point of the extended scheduled use period to the limit of the rentable period of the first storage space being no longer than a third predetermined time, may be set as the unavailability condition.

According to this configuration, when a user storing luggage in the first storage space requests extension of the scheduled use period of the first storage space but the scheduled use period cannot be extended within the rentable period of the first storage space according to the request, the destination extraction portion extracts a continuously usable second storage space near the first storage space. Then, the destination information transmission portion transmits information on the second storage space to the terminal device of the provider of the first storage space or the terminal device of the user. Hence, the provider of the first storage space or the user can transfer the luggage stored in the first storage space to the second storage space. With this, the period of storing the luggage can be extended according to requests from the user.

In another configuration, when rental reduction request information requesting reduction of a rentable period of the first storage space is received from the terminal device of the provider of the first storage space while it is detected by the usage state detection portion that the first storage space is in use or is scheduled to be used, a limit of the rentable period reduced according to the rental reduction request information being earlier than an ending time point of the scheduled use period of the first storage space, or a remaining time from the ending time point of the scheduled use period of the first storage space to the limit of the reduced rentable period being no longer than a fourth predetermined time, may be set as the unavailability condition.

According to this configuration, when the provider of the first storage space requests reduction of the rentable period but the rentable period cannot be reduced by ensuring a scheduled use period of the first storage space according to the request, the destination extraction portion extracts a continuously usable second storage space near the first storage space. Then, the destination information transmission portion transmits information on the second storage space to the terminal device of the provider of the first storage space or the terminal device of the user. Hence, the provider of the first storage space or the user can transfer luggage stored in the first storage space to the second storage space. With this, the rentable period of the first storage space can be reduced while enabling the user to collect the luggage.

In another configuration, upon receipt of transfer completion information notifying that luggage stored in the first storage space is transferred to the second storage space from the terminal device of the provider of the first storage space, the destination information transmission portion may transmit storage location change information notifying that a stored location is changed to the second storage space, to the terminal device of the user storing luggage in the first storage space.

According to this configuration, the user storing the luggage in the first storage space can check the storage location change information and know that the storage location has been changed to the second storage space. Hence, the provider of the first storage space need not notify the user of the first storage space of the change in the stored location of the luggage.

### BRIEF DESCRIPTION OF THE DRAWINGS

FIG. 1 is an explanatory drawing showing a rental form of storage spaces using a rental system;

FIG. 2 is a configuration diagram of the rental system;

FIG. 3 is a flowchart of processing of registration of a provider of a storage space and setting of a rentable period of a storage space;

FIG. 4 is a flowchart of processing for dealing with a case where a user does not come to collect luggage within a rentable period of a first storage space;

FIG. 5 is a flowchart of processing for dealing with changes of the rentable period and a scheduled use period of the first storage space;

FIG. 6 is an explanatory drawing of rental registration information;

FIG. 7 is an explanatory drawing of dealing with a case where the user of the first storage space does not come to collect stored luggage within the rentable period of the first storage space;

FIG. 8 is an explanatory drawing of dealing with a case where the user of the first storage space requests for extension of the scheduled use period of the first storage space; and

FIG. 9 is an explanatory drawing of dealing with a case where a provider of the first storage space requests for reduction of the rentable period of the first storage space.

### DETAILED DESCRIPTION OF THE PREFERRED EMBODIMENTS

### 1. Rental Form of Storage Space Using Rental System

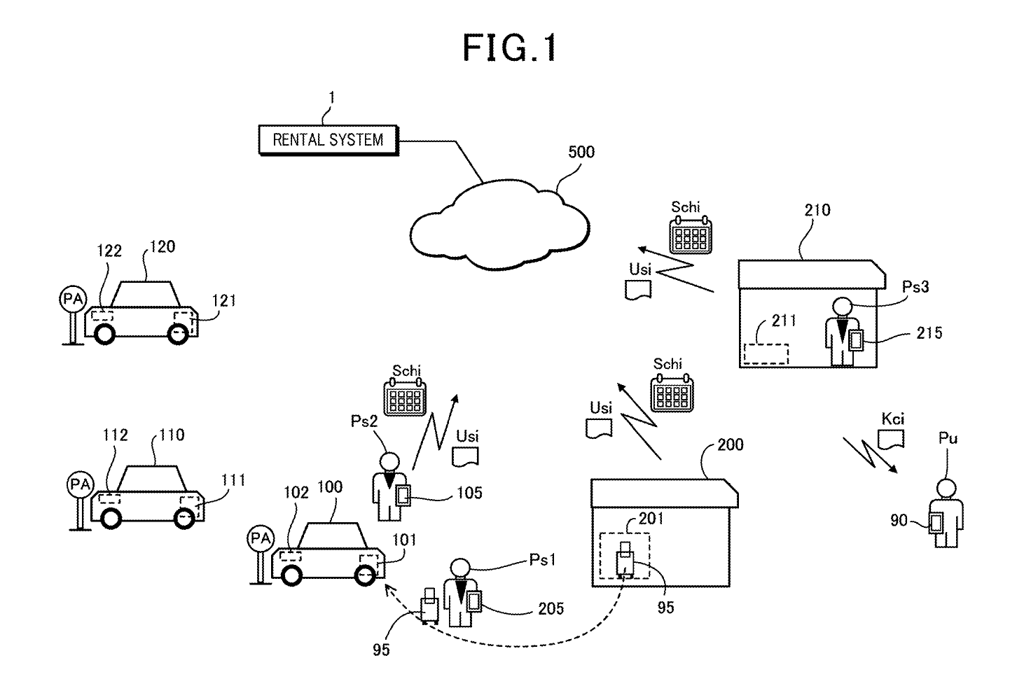

FIG. 1 shows a rental form of luggage storage spaces using a rental system of an embodiment. Referring to FIG. 1, a rental system 1 of the embodiment supports a service of renting, to a user Pu, storage spaces provided by storage space providers Ps1, Ps2, Ps3, and so on, for example.

The rental system 1 is communicably connected with terminal devices (hereinafter referred to as provider terminals) 105, 205, and 215 of the providers each providing the storage space, and a terminal device (hereinafter referred to as a user terminal) 90 of the user using the storage spaces, through a communication network 500. The communication connection between the communication elements may be wired communication or wireless communication. As the provider terminals 105, 205, and 215, and the user terminal 90, a smartphone, a cellular phone, a tablet terminal, and the like are used.

The provider Ps1 is an owner of a store 200, and provides a spare space 201 in the store 200 as a luggage storage space during store hours of the store 200. Similarly, in the case of a store 210, the provider Ps3 provides a spare space 211 of the store 210 as a storage space. Additionally, the provider Ps2 is an owner of a vehicle 100, and provides a spare space 101 of a trunk or the like of the vehicle 100 as a storage space. Similarly, spare spaces 111 and 121 are provided in vehicles 110 and 120.

The rental system 1 receives provider registration information Usi containing information on the provider Ps1 and the store 200, for example, and schedule pad information Schi indicating schedules of the provider Ps1, transmitted from the provider terminal of the provider Ps1 of the storage space 201. Then, the rental system 1 generates rental registration information containing information such as the location and the rentable period of the storage space 201 on the basis of the provider registration information Usi and the schedule pad information Schi, and stores the rental registration information in a memory.

In the cases of the other storage spaces 211, 101, 111, and 121, too, the rental system 1 generates rental registration information on the basis of the provider registration information Usi and the schedule pad information Schi transmitted from the provider terminals of the providers Ps2 and Ps3, for example, and stores the rental registration information in the memory. The locations of the storage spaces 101, 111, and 121 of the vehicles 100, 110, and 120 are the parked positions of the vehicles 100, 110, and 120. As for the parked positions, positions detected by a global positioning system (GPS) signal by control units 102, 112, and 122 respectively included in the vehicles 100, 110, and 120 may be transmitted to the rental system 1. The rental system 1 thus supports a service for renting storage spaces registered by generating the rental registration information, to users who wish to use the storage spaces.

The user Pu who is to use the storage space rental service provided by the rental system 1 operates the user terminal 90 to perform processing to register for the rental system 1. The user Pu is a traveler, for example, and uses the storage space rental service of the rental system 1 to find a location for storing luggage 95 in the middle of sightseeing.

The user Pu accesses a website of the rental system 1 by the user terminal 90, searches for a usable storage space nearby, finds a suitable storage space, and applies for use of the storage space. The example of FIG. 1 shows a state where the user Pu applies for use of the storage space 201 of the store 200 and stores the luggage 95.

The rental system 1 detects the usage state of the storage spaces 201, 211, 101, 111, and 121, and when the user does not come to collect the luggage even after the rentable period, prompts to transfer the stored luggage to another storage space nearby. The example of FIG. 1 shows a case where the user Pu stores the luggage in the storage space 201 (hereinafter referred to as a first storage space 201) of the store 200, but does not come to collect the luggage within the rentable period of the first storage space 201 which is the store hours of the store 200.

In this case, the rental system 1 extracts the storage space 101 (hereinafter referred to as a second storage space 101) of the vehicle 100 which is at or within a predetermined distance from the first storage space 201 and whose remaining rentable period is not shorter than a first predetermined time. Then, the rental system 1 transmits information (e.g., location and rentable period) on the second storage space 101 to the provider terminal 205 of the provider Ps1 of the first storage space 201.

The provider of the first storage space 201 operates the provider terminal 205 to apply to the rental system 1 for use of the second storage space 101, and then transfers the stored luggage 95 to the parked position of the vehicle 100. Then, the provider uses a virtual key provided from the rental system 1 to unlock the trunk of the vehicle 100, stores the luggage 95, and locks the trunk with the virtual key.

The rental system 1 transmits storage location change information Kci notifying that the luggage 95 has been transferred to the second storage space 101, to the user terminal 90 of the user Pu. The storage location change information Kci contains the virtual key of the vehicle 100. The user Pu can check the storage location change information Kci by the user terminal 90, know that the luggage 95 is stored in the vehicle 100, and unlock the door of the vehicle 100 by use of the virtual key to collect the luggage 95.

### 2. Rental System Configuration

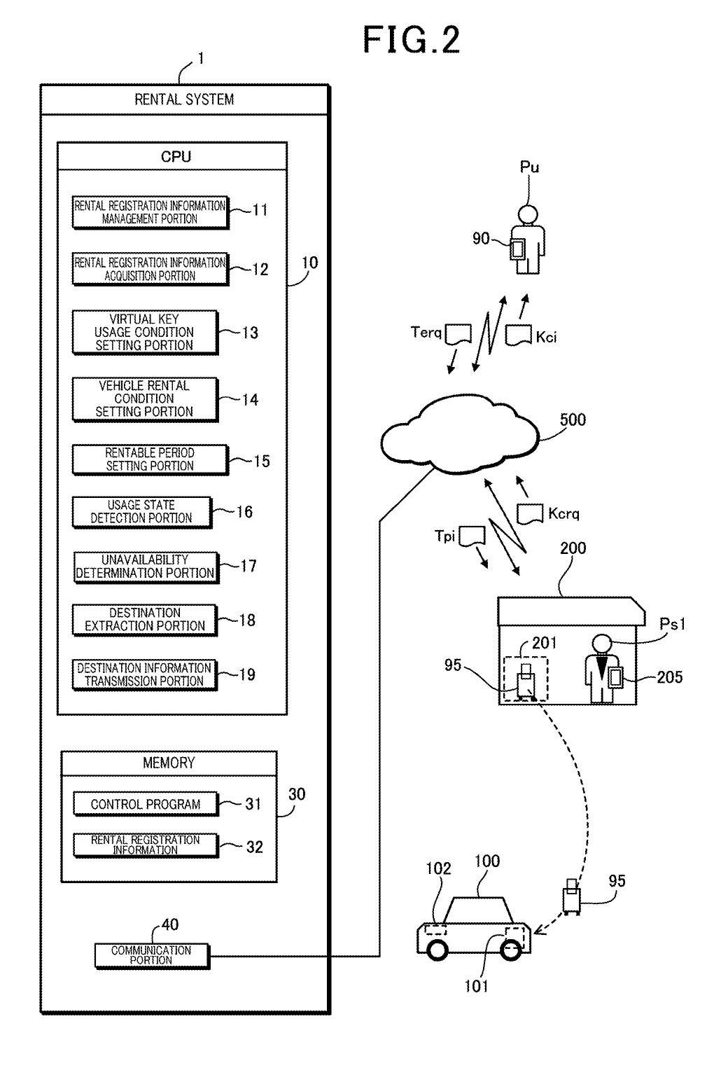

Next, FIG. 2 is a configuration diagram of the rental system 1. Referring to FIG. 2, the rental system 1 is a computer system configured of a central processing unit (CPU) 10, a memory 30, a communication portion 40, various interface circuits (not shown), and other parts. The CPU 10 reads and executes a control program 31 of the rental system 1 stored in the memory 30, to thereby function as a rental registration information management portion 11, a rental registration information acquisition portion 12, a virtual key usage condition setting portion 13, a vehicle rental condition setting portion 14, a rentable period setting portion 15, a usage state detection portion 16, an unavailability determination portion 17, a destination extraction portion 18, and a destination information transmission portion 19.

The memory 30 stores therein, in addition to the control program 31, rental registration information 32, for example, in which information on the providers having registered for use of the storage space rental service using the rental system 1 and the storage spaces is recorded. The configuration of storing the rental registration information 32 in the memory 30 corresponds to the rental registration information storage portion of the present invention.

The rental registration information management portion 11 receives the provider registration information Usi (containing a name and information on a store or a vehicle including a provided space, for example) and the schedule pad information Schi indicating schedules, transmitted from the provider terminal of the provider of the storage space, issues a provider ID which is identification information on each provider, generates the rental registration information 32, and stores the rental registration information 32 in the memory 30. Additionally, when the provided storage space is a vehicle compartment, the rental registration information management portion 11 receives the virtual key for unlocking the door of the vehicle from the provider terminal.

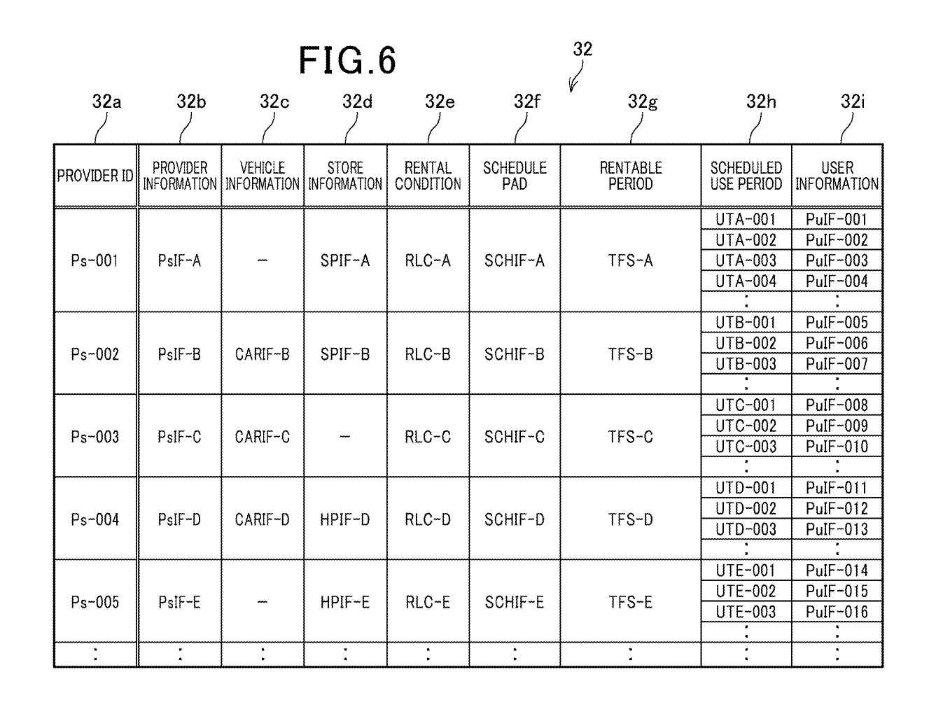

As shown in FIG. 6, provider information 32b (e.g., the name of the provider and a communication address of the provider terminal used by the provider), vehicle information 32c (e.g., the parked position, a vehicle type, a registration number, a color, and the virtual key), store information 32d (e.g., the location, the store name, and opening time), a rental condition 32e (e.g., a storable luggage size and rental of the trunk only in the case of a vehicle), a schedule pad 32f, a rentable period 32g, a scheduled use period 32h, and user information 32i (e.g., the communication address of the user terminal used by the user) are recorded in association with a provider ID 32a of each provider who registered for rental of the storage space, in the rental registration information 32.

The rental registration information acquisition portion 12 reads out the rental registration information 32 stored in the memory 30, and acquires information recorded in the rental registration information 32. In addition, when the rental registration information 32 is stored in an external server or the like other than the rental system 1, the rental registration information acquisition portion 12 accesses the external server or the like and reads out information recorded in the rental registration information 32.

When the storage space is a vehicle compartment, the virtual key usage condition setting portion 13 sets use conditions of a virtual key lent from the provider of the storage space in the following manner, for example, according to the provider's requests.

(Use condition 1) Prohibit start (ignition ON) of the vehicle by the virtual key. This prevents use of the vehicle other than use as a storage space.

(Use condition 2) Limit the period during which the door of the vehicle is unlockable by the virtual key to only within the scheduled use period of the storage space, and prohibit unlocking of the vehicle door by the virtual key outside the scheduled use period. With this, it is possible to avoid unlocking of the vehicle door outside the scheduled use period.

(Use condition 3) Limit unlocking of the vehicle door using the virtual key only to doors other than the driver's seat, and prohibit unlocking of the door of the driver's seat using the virtual key. With this, it is possible to avoid a situation where the driver's seat position is changed when storing luggage in the driver's seat and the driver needs to reposition the driver's seat when using the vehicle.

(Use condition 4) Limit unlocking of the vehicle door using the virtual key only to the trunk, and prohibit unlocking of doors other than the trunk. This can prevent soiling of the compartment due to loading and unloading of luggage to and from the compartment.

The vehicle rental condition setting portion 14 sets rental conditions for renting a vehicle compartment as a storage space in the following manner, for example, according to requests of the provider of the storage space.

(Rental condition 1) Prohibit rental when precipitation falls or there is chance of precipitation. By setting Rental condition 1, it is possible to avoid wetting of the inside of the vehicle compartment during loading and unloading of luggage to and from the vehicle compartment when the vehicle compartment is rented out as a storage space during precipitation such as rain, snow, and sleet.

(Rental condition 2) Prohibit rental when a trouble occurs in the vehicle. By setting Rental condition 2, it is possible to prevent a situation where a storage space is rented out with low remaining battery capacity, and the door can be unlocked to load or unload luggage but cannot be locked afterwards, for example.

The rentable period setting portion 15 sets a rentable period of a storage space of a store or a vehicle on the basis of the schedule pad 32 f of the rental registration information 32. As for a store, for example, when the following target schedule is registered in the schedule pad 32f, the rentable period setting portion 15 sets the period of the target schedule as a rentable period.

(Target schedule of store) Store hours of the store. Within the store hours, there is staff in the store and luggage can be received and handed out. Hence, by setting the store hours as the rentable period, a spare space in the store can be effectively utilized.

As for the vehicle, for example, when the following target schedule is registered in the schedule pad 32f, the rentable period setting portion 15 sets the period of the target schedule as a rentable period.

(Target schedule of vehicle) Traveling by train. The vehicle is not used at the time of travel by train. Hence, by setting the time of travel by train as the rentable period, the spare vehicle compartment can be effectively utilized.

The usage state detection portion 16 monitors usage information on each storage space registered in the rental registration information 32 on the basis of information on starting and ending of use of the storage space transmitted from the provider terminal of the provider of the storage space. The unavailability determination portion 17 determines whether a later-mentioned unavailability condition is met for a storage space detected as being used by the usage state detection portion 16.

The destination extraction portion 18 extracts a storage space (second storage space) for transferring stored luggage, when a currently used storage space (first storage space) exceeds the limit of the rentable period or the remaining time left before the rentable limit becomes short. The destination information transmission portion 19 transmits the information on the second storage space extracted by the destination extraction portion 18 to the provider terminal of the provider of the first storage space.

### 3. Recording of Rental Registration Information and Setting of Rentable Period

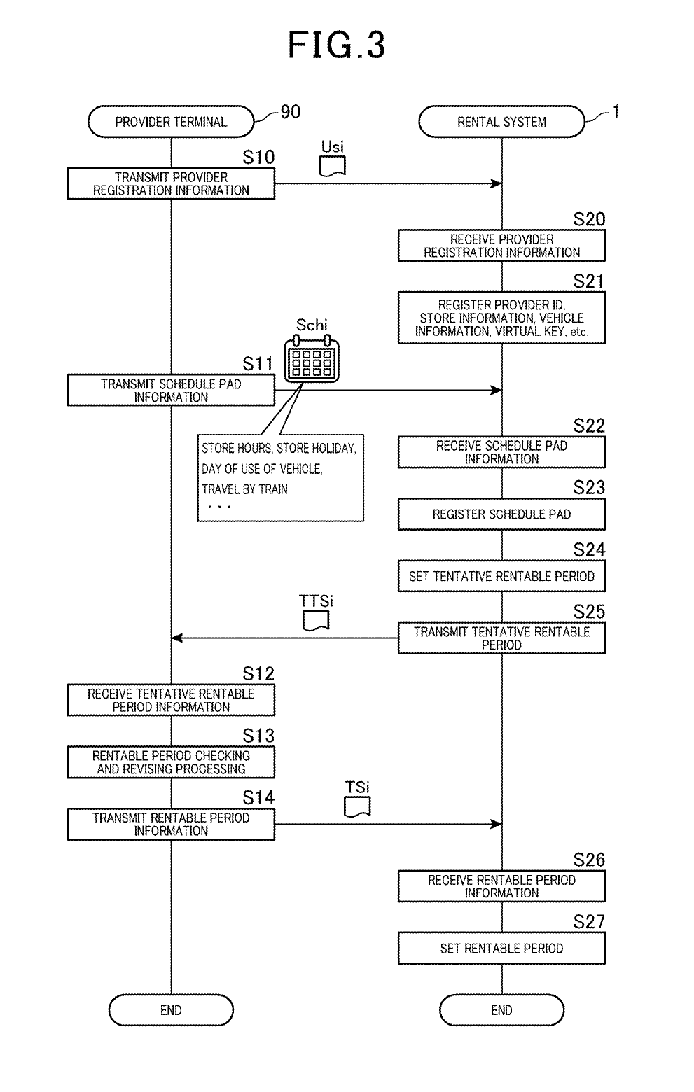

Next, processing, by the rental system 1, of recording rental registration information of a rental space and setting a rentable period of the rental space on the basis of information transmitted from a provider terminal will be described according to a flowchart shown in FIG. 3.

In step S10, a provider terminal transmits the provider registration information Usi to the rental system 1 in response to an operation of a provider of a storage space. In step S20, the rental registration information management portion 11 of the rental system 1 receives the provider registration information Usi. Then, in the next step S21, the rental registration information management portion 11 registers the provider ID 32a issued for the provider, and the provider information 32b, the vehicle information 32c, and the store information 32d contained in the provider registration information Usi as shown in FIG. 6.

In step S11, the provider terminal transmits the schedule pad information Schi managed by a schedule management application used in the provider terminal to the rental system 1. The rental registration information management portion 11 receives the schedule pad information Schi in step S22, and records the schedule pad information Schi in the rental registration information 32 in the next step S23.

In the next step S24, the rentable period setting portion 15 sets a rentable period of the storage space as mentioned earlier, on the basis of the schedule of the provider recorded in the schedule pad. Then, in step S25, the rentable period setting portion 15 transmits tentative rentable period information TTSi indicating a tentative rentable period to the provider terminal.

The provider terminal receives the tentative rentable period information TTSi in step S12, and displays the tentative rentable period on a display portion to perform rentable period checking and revising processing for prompting checking and revision by the provider in the next step S13. The rentable period checking and revising processing sets a rentable period confirmed by the provider.

In the next step S14, the provider terminal transmits rentable period information TSi indicating the rentable period to the rental system 1. In step S26, the rentable period setting portion 15 of the rental system 1 receives the rentable period information TSi. In the next step S27, the rentable period setting portion 15 records the rentable period indicated by the rentable period information TSi in the schedule pad 32f of the rental registration information 32.

Thus, the rental registration information management portion 11 receives application for use of the storage space by the user within the rentable period 32g of each storage space recorded in the rental registration information 32. Then, the rental registration information management portion 11 sequentially records the applied scheduled use period 32h and the user information 32i on the applied user in the rental registration information 32.

In the example of FIG. 6, a rentable period TFS-A is set for a user assigned with a provider ID Ps-001, and scheduled use periods UTA-001, UTA-002, UTA-003, . . . and user information PuIF-001, PuIF-002, PuIF-003, . . . are registered within the rentable period TFS-A.

### 4. Changes in Scheduled Use Period and Rentable Period

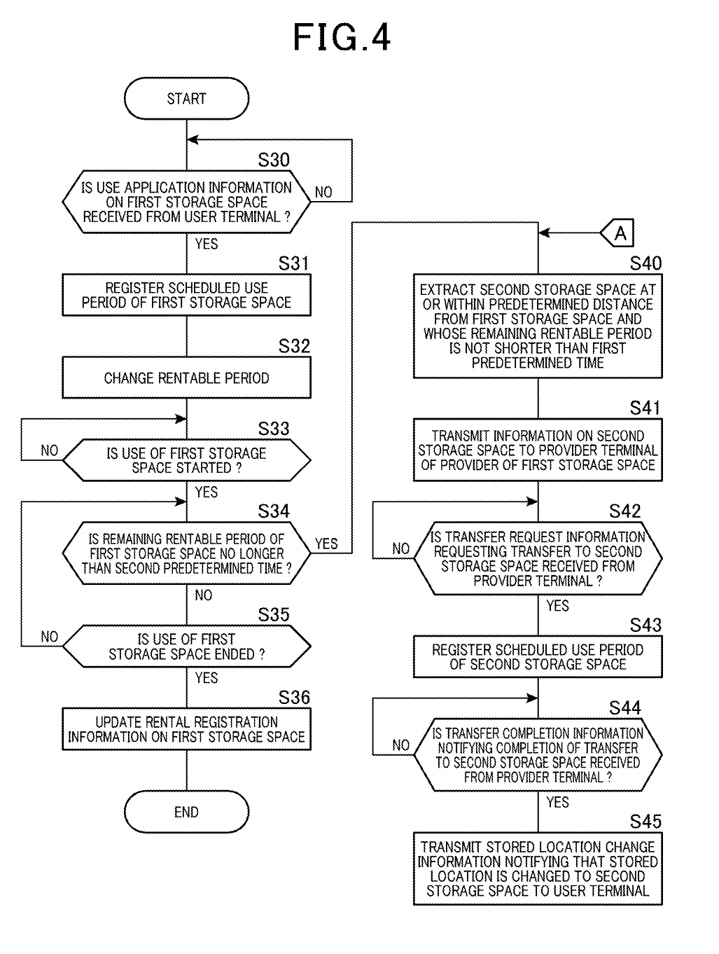

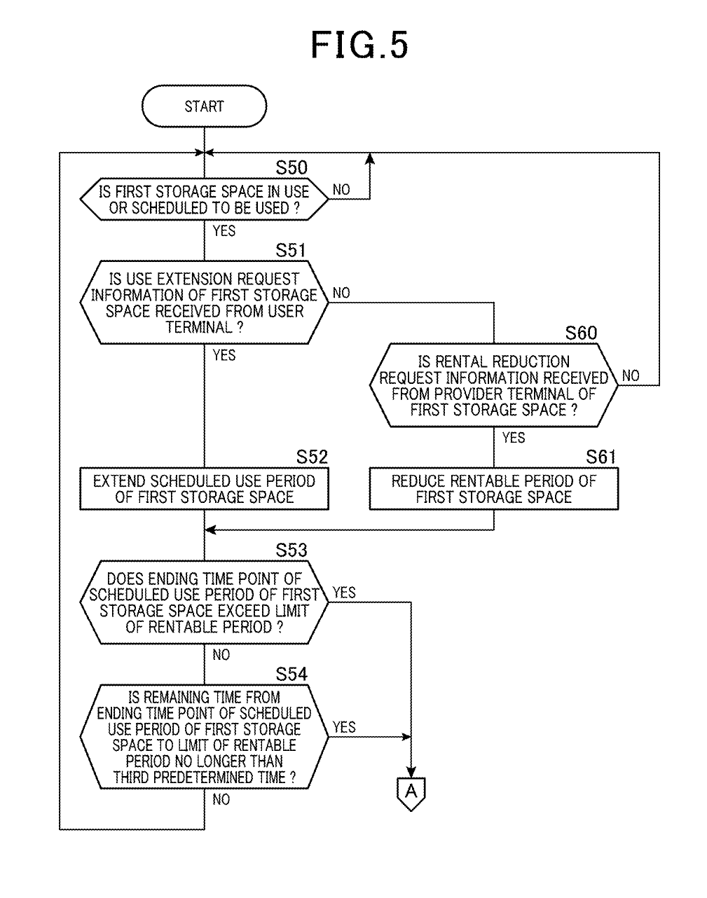

Processing for dealing with a change in the scheduled use period or the rentable period of a storage space will be described with reference to the flowcharts shown in FIGS. 4 and 5. Hereinbelow, a case where the user Pu stores the luggage 95 in the first storage space 201 of the store 200 as shown in FIG. 1 will be described. As mentioned earlier, in FIG. 1, since the user Pu cannot collect the luggage 95 within the rentable period of the first storage space 201, the luggage 95 is transferred to the second storage space 101 of the vehicle 100.

Steps S30 to S32 in FIG. 4 illustrate processing by the rental registration information management portion 11. Upon receipt of use application information on the first storage space 201 from the user terminal 90 of the user Pu in step S30, the rental registration information management portion 11 proceeds with the processing to step S31. In step S31, the rental registration information management portion 11 registers the scheduled use period of the first storage space 201 set at the time of the use request in the rental registration information, on the basis of the use application information. In the next step S32, the rental registration information management portion 11 changes the rentable period of the first storage space 201 according to the registration of the scheduled use period.

The next steps S33 to S35 illustrate processing by the unavailability determination portion 17. Upon detection of start of use of the first storage space 201 by the usage state detection portion 16 in step S33, the unavailability determination portion 17 proceeds with the processing to step S34. In step S34, the unavailability determination portion 17 refers to the rental registration information 32 and determines whether the remaining time of the rentable period of the first storage space 201 is no longer than a second predetermined time. The determination condition corresponds to the unavailability condition of the present invention.

Then, the unavailability determination portion 17 proceeds with the processing to step S40 if the remaining time of the rentable period of the first storage space 201 is no longer than the second predetermined time, and proceeds with the processing to step S35 if the remaining time of the rentable period of the first storage space 201 is longer than the second predetermined time.

In step S35, the unavailability determination portion 17 determines whether an end of use of the first storage space 201 is detected by the usage state detection portion 16. Then, if use of the first storage space 201 is ended, the unavailability determination portion 17 proceeds with the processing to step S36. In step S36, the rental registration information management portion 11 updates the rental registration information on the first storage space 201 according to the end of use of the first storage space 201.

Moreover, in step S40, the destination extraction portion 18 extracts the second storage space 101 that is at or within a predetermined distance from the first storage space 201, and whose remaining rentable period is not shorter than a first predetermined time. In the next step S41, the destination information transmission portion 19 transmits information (e.g., a location, a rentable period, and a virtual key) on the second storage space 101 to the provider terminal 205 of the provider Ps1 of the first storage space 201.

Here, in step S41, instead of the transmission of the information on the second storage space 101 to the provider terminal 205 of the provider Ps1, or in addition to the transmission to the provider terminal 205, information on the second storage space 101 may be transmitted to the user terminal 90 of the user Pu. In this case, the user Pu can check the information on the second storage space 101 by the user terminal 90, and send a request to the rental system 1 to transfer the luggage 95 stored in the first storage space 201 to the second storage space 101.

Upon receipt of the transfer request information requesting a transfer to the second storage space 101 from the provider terminal 205 in the next step S42, the destination information transmission portion 19 proceeds with the processing to step S43. Then, in step S43, the destination information transmission portion 19 registers the scheduled use period of the second storage space 101 in the rental registration information 32.

Here, the provider Ps1 of the first storage space 201 transfers the luggage 95 stored in the first storage space 201 to the second storage space 101 of the vehicle 100. Then, the provider Ps1 transmits transfer completion information notifying completion of the transfer to the rental system 1. Upon receipt of the transfer completion information in step S44, the destination information transmission portion 19 proceeds with the processing to step S45.

In step S45, the destination information transmission portion 19 transmits storage location change information notifying that the storage location of the luggage 95 has been changed to the second storage space 101 to the user terminal 90. The user Pu can check the storage location change information by the user terminal 90 and know that the luggage 95 is stored in the second storage space 101. Then, the user Pu heads to a parked position of the vehicle 100, performs short-distance wireless communication such as Bluetooth low energy (BLE, Bluetooth is a registered trademark) and near field communication (NFC) between the user terminal 90 and the control unit 102 of the vehicle 100, and unlocks the door of the vehicle 100 by the virtual key. Then, the user Pu can collect the luggage 95 stored in the vehicle 100.

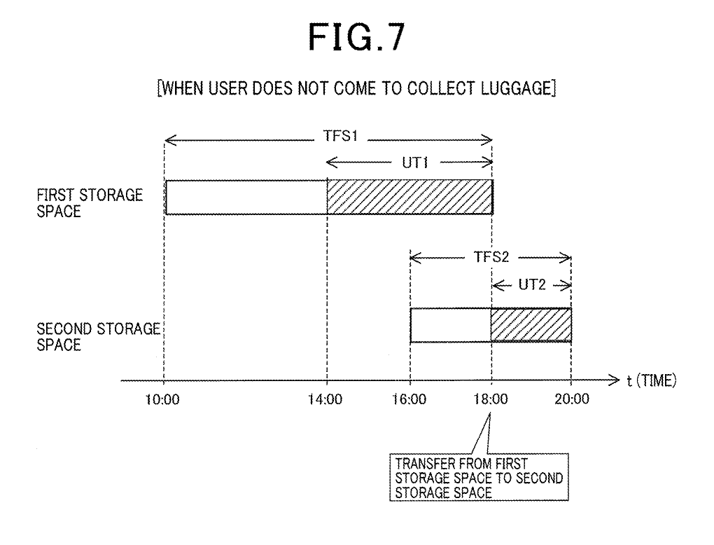

Here, as mentioned earlier, FIG. 7 shows an example of dealing with a case where, while a scheduled use period UT1 (14:00 to 18:00) of the first storage space 201 is set within a rentable period TFS1 (10:00 to 18:00) of the first storage space 201, the user Pu does not come to collect luggage even after the limit (18:00) of the rentable period TFS1 of the first storage space 201.

In this case, the destination extraction portion 18 extracts the second storage space 101 that is at or within a predetermined distance from the first storage space 201, and whose remaining time (two hours from 18:00 to 20:00) of a rentable period TFS2 (16:00 to 20:00) is not shorter than a second predetermined time. Then, the destination extraction portion 18 sets the remaining time of the second storage space to a scheduled use period UT2.

Accordingly, the scheduled use period of the luggage 95 of the user Pu is UT1+UT2 and is extended by two hours, whereby the user Pu can collect the luggage 95 from the second storage space 101 of the vehicle 100 until 20:00.

Next, FIG. 5 illustrates processing for dealing with a case where extension of the scheduled use period of the first storage space 201 is requested by the user Pu, and a case where reduction of the rentable period of the first storage space 201 is requested by the provider Ps1 of the first storage space 201.

When it is detected in step S50 by the usage state detection portion 16 that the first storage space 201 is in use or is scheduled to be used, the unavailability determination portion 17 proceeds with the processing to step S51. In step S51, the unavailability determination portion 17 determines whether use extension request information requesting extension of the scheduled use period of the first storage space 201 is received from the user terminal 90 of the user Pu. Then, the unavailability determination portion 17 proceeds with the processing to step S52 if the use extension request information is received, and proceeds with the processing to step S60 if the use extension request information is not received.

In step S52, the unavailability determination portion 17 extends the scheduled use period of the first storage space 201 according to the use extension request information. In the next step S53, the unavailability determination portion 17 determines whether the ending time point of the extended scheduled use period of the first storage space 201 exceeds the limit of the first storage space 201. The determination condition corresponds to the unavailability condition of the present invention. Then, if the ending time point of the extended scheduled use period of the first storage space 201 exceeds the limit of the first storage space 201, the unavailability determination portion 17 proceeds with the processing to step S40 of FIG. 4. In this case, as mentioned earlier, the second storage space 101 as the destination of the luggage 95 is extracted.

Meanwhile, if the ending time point of the extended scheduled use period of the first storage space 201 is within the limit of the first storage space 201, the unavailability determination portion 17 proceeds with the processing to step S54. In step S54, the unavailability determination portion 17 determines whether the remaining time from the ending time point of the scheduled use period of the first storage space 201 to the limit of the rentable period of the first storage space 201 is no longer than a third predetermined time. The determination condition corresponds to the unavailability condition of the present invention.

Then, if the time from the ending time point of the scheduled use period of the first storage space 201 to the limit of the rentable period of the first storage space 201 is no longer than the third predetermined time, the unavailability determination portion 17 proceeds with the processing to step S40 of FIG. 4. In this case, as mentioned earlier, the second storage space 101 as the destination of the luggage 95 is extracted. Meanwhile, if the time from the ending time point of the scheduled use period of the first storage space 201 to the limit of the rentable period of the first storage space 201 is longer than the third predetermined time, the unavailability determination portion 17 proceeds with the processing to step S50.

Additionally, in step S60, the unavailability determination portion 17 determines whether rental reduction request information requesting reduction of the rentable period of the first storage space 201 is received from the provider terminal 205 of the provider Ps1 of the first storage space 201. Then, the unavailability determination portion 17 proceeds with the processing to step S61 if rental reduction request information is received, and proceeds with the processing to step S50 if rental reduction request information is not received. In step S61, the unavailability determination portion 17 reduces the rentable period of the first storage space 201 according to the rental reduction request information, and proceeds with the processing to step S53.

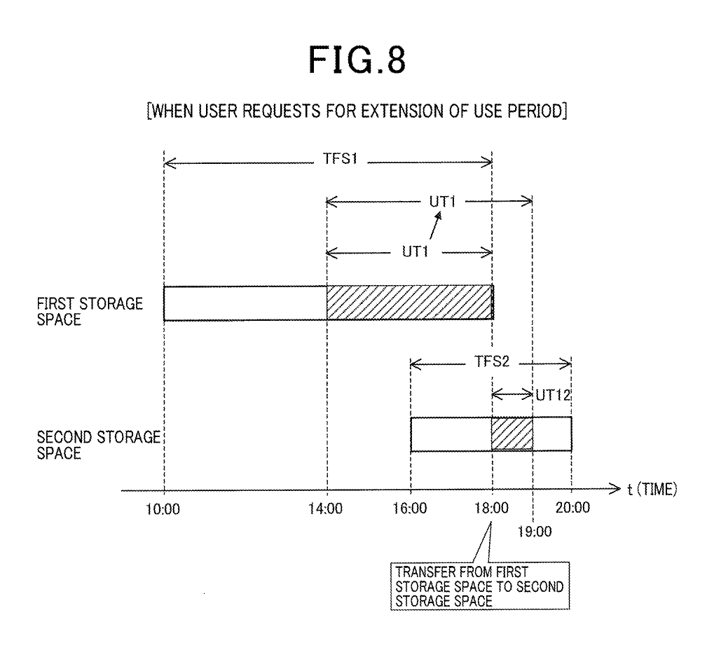

Here, FIG. 8 shows an example of dealing with a case where, while the scheduled use period UT1 (14:00 to 18:00) of the first storage space 201 was initially set within the rentable period TFS1 (10:00 to 18:00) of the first storage space 201, the scheduled use period UT1 of the first storage space 201 is extended by an hour according to a request from the user Pu.

In this case, the unavailability determination portion 17 extends the scheduled use period UT1 of the first storage space 201 by an hour in step S52 of FIG. 5, and then proceeds with the processing from step S53 to step S40 of FIG. 4. Then, the destination extraction portion 18 extracts the second storage space 101 that is at or within a predetermined distance from the first storage space 201, and whose remaining time from the ending time point (19:00) of the scheduled use period UT1 to the limit (20:00) of the rentable period is not shorter than the third predetermined time. Then, the destination extraction portion 18 sets an hour from 18:00 to 19:00 of TFS2 of the second storage space 101 as the scheduled use period UT12 for the user Pu.

Accordingly, the scheduled use period of the luggage 95 of the user Pu is extended by an hour and secured, whereby the user Pu can collect the luggage 95 from the second storage space 101 of the vehicle 100 until 19:00.

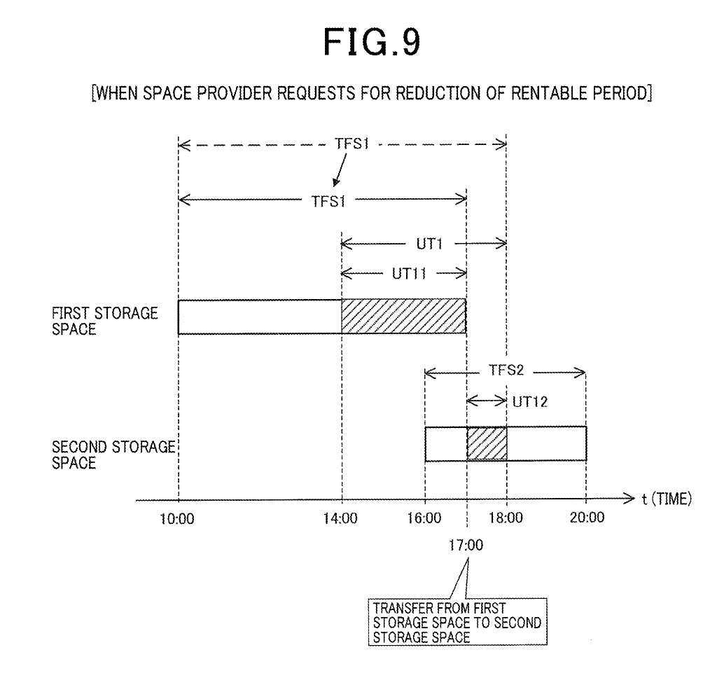

Additionally, FIG. 9 shows an example of dealing with a case where, while the scheduled use period UT1 of the user Pu was initially set within the rentable period TFS1 (10:00 to 18:00) of the first storage space 201, the rentable period TFS1 of the first storage space 201 is reduced by an hour according to a request from the provider of the first storage space 201.

In this case, the unavailability determination portion 17 reduces the rentable period TFS1 of the first storage space 201 by an hour in step S61 of FIG. 5, and then proceeds with the processing from step S53 to step S40 of FIG. 4. Then, the destination extraction portion 18 extracts the second storage space 101 that is at or within a predetermined distance from the first storage space 201, and whose remaining time from the ending time point (18:00) of the scheduled use period UT1 to the limit (20:00) of the rentable period TFS2 is not shorter than the third predetermined time (corresponding to a fourth predetermined time of the present invention). Then, the destination extraction portion 18 sets UT12 from 17:00 to 18:00 of the rentable period TFS2 of the second storage space 101 as the scheduled use period UT12 for the user Pu.

Accordingly, 17:00 to 18:00 of the scheduled use period UT1 of the luggage 95 of the user Pu is ensured by UT12 within the rentable period TFS2 of the second storage space 101, whereby the user Pu can collect the luggage 95 from the second storage space 101 of the vehicle 100 until 18:00.

### 4. Other Embodiments

Although spare spaces of store and a vehicle are used as examples of a storage space to be rented in the above embodiment, spare spaces of a private residence, public facilities, and the like may also be used as a storage space to be rented.

Although the above embodiment includes a configuration in which the rentable period setting portion 15 sets a rentable period of a storage space on the basis of the schedule pad of the provider of the storage space, effects of the present invention can be obtained even when the configuration is omitted.

The above embodiment includes a configuration in which the destination extraction portion 18 extracts the second storage space as a destination, when extension of the scheduled use period is requested and the ending time point of the extended scheduled use period exceeds the limit of the rentable period of the first storage space, or the remaining time from the ending time point of the extended scheduled use period to the limit of the rentable period of the first storage space is no longer than the second predetermined time. However, effects of the present invention can be obtained even when the configuration is omitted.

The above embodiment includes a configuration in which the destination extraction portion 18 extracts the second storage space as a destination, when reduction of the rentable period is requested by the provider of the first storage space and the limit of the reduced rentable period is earlier than the ending time point of the scheduled use period of the first storage space by the user, or the remaining time from the ending time point of the scheduled use period to the limit of the reduced rentable period is no longer than the third predetermined time. However, effects of the present invention can be obtained even when the configuration is omitted.

Although the above embodiment includes a configuration in which the storage location change information is transmitted from the rental system 1 to the user terminal 90 of the user Pu to notify that luggage is transferred from the first storage space to the second storage space, the configuration may be omitted. In this case, for example, the provider Ps1 of the first storage space may transmit, from the provider terminal 205 to the user terminal 90 of the user Pu, an email notifying that the luggage is transferred from the first storage space to the second storage space.

Additionally, when the provider of the first storage space transfers the luggage to the second storage space extracted by the destination extraction portion 18 because the user does not come to collect the luggage at the first storage space within the scheduled use period, and when the luggage is transferred to the second storage space because the usable period is extended by a request from the user, billing information for charging additional payment may be transmitted to the user terminal of the user.

Moreover, in another configuration, when the destination extraction portion 18 extracts the second storage space that meets the extraction condition (at or within a predetermined distance from the first storage space, and whose remaining time of the rentable period is not shorter than the second predetermined time), information on multiple second storage spaces may be transmitted to the user terminal, so that the user can select any of the second storage spaces.

Additionally, when the user is able to collect the luggage at the first storage space due to a sudden change in schedule of the user, if transfer of the luggage from the first storage space to the second storage space is not started, the user can access the rental system 1 by the user terminal and request to cancel the transfer of the luggage to the second storage space.

Additionally, when the transfer of the luggage from the first storage space to the second storage space is started, the rental system 1 may notify to the user terminal that the luggage is being transferred.

Note that FIG. 2 is a schematic diagram in which the functional configuration of the rental system 1 is partitioned according to main processing contents, for the sake of simplicity of the invention of the present application. The configuration of the rental system 1 may be partitioned according to other contents. Processing by the components may be executed by a single hardware unit, or may be executed by multiple hardware units. Processing of the components may be executed by a single program, or may be executed by multiple programs.

### REFERENCE SIGNS LIST

1 . . . rental system, 10 . . . CPU, 11 . . . rental registration information management portion, 12 . . . rental registration information acquisition portion, 13 . . . virtual key use condition setting portion, 14 . . . vehicle rental condition setting portion, 15 . . . rentable period setting portion, 16 . . . usage state detection portion, 17 . . . unavailability determination portion, 18 . . . destination extraction portion, 19 . . . destination information transmission portion, 30 . . . memory, 31 . . . control program, 32 . . . rental registration information, 40 . . . communication portion, 90 . . . user terminal, 95 . . . user luggage, 100 . . . vehicle, 101 . . . second storage space, 200 . . . store, 201 . . . first storage space, 205 . . . provider terminal

What is claimed is:

1. A rental system comprising:
a rental registration information acquisition portion that acquires, from a rental registration information storage portion that stores therein rental registration information containing a location of a luggage storage space, a rentable period of the storage space, and information on a terminal device used by a provider of the storage space, for each of a plurality of storage spaces, the rental registration information of each storage space;
a usage state detection portion that detects a usage state of a storage space having the rental registration information stored in the rental registration information storage portion;
an unavailability determination portion that determines, when it is detected by the usage state detection portion that a first storage space having the rental registration information stored in the rental registration information storage portion is in use or is scheduled to be used, whether an unavailability condition indicating inability of use of the first storage space is met;
a destination extraction portion that, when it is determined by the unavailability determination portion that the unavailability condition is met, extracts a second storage space that is at or within a predetermined distance from the first storage space and whose remaining time of the rentable period is not shorter than a first predetermined time, from among other storage spaces having the rental registration information stored in the rental registration information storage portion; and
a destination information transmission portion that transmits information on the second storage space extracted by the destination extraction portion to a terminal device of a provider of the first storage space or a terminal device of a user of the first storage space.

2. The rental system according to claim 1, wherein
detection by the usage state detection portion that the first storage space is continuously used when the remaining time of the rentable period indicated by the rental registration information is no longer than a second predetermined time, is set as the unavailability condition.

3. The rental system according to claim 1, wherein
when use extension request information requesting extension of a scheduled use period of the first storage space initially set at the time of requesting usage is received from the terminal device of the user of the first storage space while it is detected by the usage state detection portion that the first storage space is in use or is scheduled to be used, an ending time point of the scheduled use period extended according to the use extension request information exceeding a limit of the rentable period of the first storage space, or the remaining time from the ending time point of the extended scheduled use period to the limit of the rentable period of the first storage space being no longer than a third predetermined time, is set as the unavailability condition.

4. The rental system according to claim 1, wherein
when rental reduction request information requesting reduction of the rentable period of the first storage space is received from the terminal device of the provider of the first storage space while it is detected by the usage state detection portion that the first storage space is in use or is scheduled to be used, a limit of the rentable period reduced according to the rental reduction request information being earlier than an ending time point of the scheduled use period of the first storage space, or the remaining time from the ending time point of the scheduled use period of the first storage space to the limit of the reduced rentable period being no longer than a fourth predetermined time, is set as the unavailability condition.

5. The rental system according to claim 1, wherein
upon receipt of transfer completion information notifying that luggage stored in the first storage space is transferred to the second storage space from the terminal device of the provider of the first storage space, the destination information transmission portion transmits storage location change information notifying that a stored location is changed to the second storage space, to the terminal device of the user storing luggage in the first storage space.
